(19) United States
(12) Patent Application Publication
(10) Pub. No.: US 2026/0049738 A1
(43) Pub. Date: Feb. 19, 2026

(54) PUMP FOR A ZONED HEATING OR COOLING SYSTEM AND METHOD FOR CONTROLLING A PUMP

(71) Applicant: Grundfos Holding A/S, Bjerringbro (DK)

(72) Inventors: Lars Sund MORTENSEN, Bjerringbro (DK); Mathias Skødt LARSEN, Bjerringbro (DK); Erik Baasch SØRENSEN, Bjerringbro (DK); Ole BECH-LISBERG, Bjerringbro (DK)

(21) Appl. No.: 19/102,063

(22) PCT Filed: Aug. 10, 2023
(86) PCT No.: PCT/EP2023/072199

§ 371 Date: Feb. 7, 2025

(30) Foreign Application Priority Data
Aug. 11, 2022 (DK) PA202270404

(51) Int. Cl. F24F 11/85; F04D 15/00; F24F 11/74

(52) U.S. Cl. CPC F24F 11/85; F04D 15/0066; F24D 19/10; F24F 11/74; F05D 2270/303; F05D 2270/3061

(57) ABSTRACT

One aspect of the present disclosure relates to a pump for a zoned heating or cooling system, the pump being configured to be started and stopped based on a sensed zone temperature of a zone of the zoned heating or cooling system, wherein the pump comprises a pump controller configured to: responsive to receiving a start trigger, control the pump to start pump operation in a first operational mode; in the absence of a stop trigger during at least a first time interval after receipt of the start trigger, to automatically control the pump to change pump operation after the first time interval to a second operational mode, different from the first operational mode; and responsive to receiving a stop trigger, to control the pump to stop pump operation.

### TECHNICAL FIELD

The present disclosure relates to a pump for a zoned heating or cooling system, such as a zoned heating, ventilation and/or air-conditioning (HVAC) system and to a method for controlling a pump in a zoned heating or cooling system.

### BACKGROUND

Many heating or cooling systems use a fluid as a medium for transporting energy from a source to a plurality of receivers throughout a building or other structure. Examples of fluid-based heating or cooling systems include so-called heating, ventilation and/or air-conditioning (HVAC) systems, which may provide heating, cooling, ventilation, air conditioning or a combination thereof. A zoned heating or cooling system, such as a zoned HVAC system, divides a building, such as a domestic or commercial building, into multiple zones, such that the room temperature in each zone is controlled by its own thermostat. A zoned heating or cooling system may include multiple pumps, each for supplying fluid to a respective one of the zones.

It is generally desirable to provide a zoned heating or cooling system that provides a high level of comfort to occupants of a building. It is further generally desirable to provide a zoned heating or cooling system that can adapt to varying situations or to varying needs. It is further generally desirable to provide a heating or cooling system that is energy efficient while also providing a high operational performance at low initial cost and/or low operational costs.

US 2020/0393144 discloses a multiple zone HVAC control apparatus that senses and responds to changes in duct air pressure in order to prevent undesirable zone conditioning, energy loss and register noise. This prior art system comprises an air circulator fan and multiple motorized dampers for controlling airflow to respective zones of a multiple zone HVAC system. The system includes a controller board that controls the air circulator fan and the multiple dampers responsive to input from multiple thermostats and from a pressure sensor.

However, the above prior art system requires the dampers and the motor to be controlled by a central control board.

Many zoned heating or cooling systems include multiple pumps for controlling fluid flow to respective zones of a network of fluid conduits, responsive to control signals from respective thermostats associated with the respective zones. Accordingly, there remains a need for an efficient pump control of the individual pumps that provides an efficient temperature control in the individual zones without or at least only minimal need for a centralized control.

It is further desirable to provide a pump and a control process for a pump that is easy to install and does not require complex sensory input, detailed centralized control or communication between multiple pumps of the system.

### SUMMARY

Various aspects disclosed herein seek to address the above and/or other matters or at least seek to provide an approach that may serve as an alternative to existing approaches.

According to one aspect, disclosed herein are embodiments of a pump for a zoned heating or cooling system, in particular a zoned HVAC system. In various embodiments, the pump is configured the pump being configured to be started and stopped based on a sensed zone temperature of a zone of the zoned heating or cooling system, and the pump comprises a pump controller configured to:
responsive to receiving a start trigger, control the pump to start pump operation in a first operational mode;
in the absence of a stop trigger during at least a first time interval after receipt of the start trigger, to automatically control the pump to change pump operation after the first time interval to a second operational mode, different from the first operational mode; and
responsive to receiving a stop trigger, to control the pump to stop pump operation.

In particular, in at least some embodiments, the pump controller is configured to control the pump operation of the pump based on the start and stop triggers as only external control inputs to the pump. In addition to the start and stop triggers, the pump controller mat be configured to base control of the pump operation on internal operational information about the pump. Examples of such internal information include information about a current speed of an impeller of the pump, a current motor power of a pump motor of the pump, a current fluid flow through the pump or a current fluid pressure, and/or the like.

The pump controller thus efficiently controls operation of the pump without having to rely on input from other zones of a multi-zone system, in particular without relying on input received from other pumps, information about sensed temperatures in other zones, or on additional control input from a central control unit other than the start and stop triggers. The pump merely requires external start and stop triggers based on a sensed zone temperature in the zone associated with the pump, i.e. in the zone that the pump supplies with fluid. The pump does not rely on any feedback available for the control algorithm on the conditions within the other zones of the zoned heating or cooling system.

Various embodiments disclosed herein compensate for the lack of information by implementing a time-based control strategy, which has been found to provide an efficient control of the heating or cooling system, resulting in satisfactory comfort at low operational complexity and relatively low energy consumption. Moreover, installation and configuration of the pump may be kept simple, in particular as simple as selecting an automatic control mode for multi-zone operation. In particular, the pump initially operates at a first operational mode and, if the pump has not received a stop trigger after a first time interval, the pump transitions to a second operational mode, in particular a mode associated with a higher flow. Accordingly, only if operation in the first operational mode is not sufficient to provide sufficient heating or cooling within the first time interval, various embodiments of the pump change operation to a second operational mode, which typically involves a higher energy consumption.

The sensed zone temperature may be a room temperature or other sensed temperature associated with the zone that is supplied with fluid by the pump. The sensed zone temperature may be sensed by a thermostat implementing a temperature regulation process that generates the start and stop triggers, in particular so as to maintain the zone temperature at a desired level or within a desired range.

In some embodiments, the start and stop triggers may simply involve switching the operational power to the pump ON- and OFF, respectively. Accordingly, the pump may be configured to receive the start and stop triggers as a start and stop, respectively, of receipt of operational power for driving the pump, i.e. pump operation does not require any further control signals in addition to switching the power ON and OFF, thus reducing manufacturing and installation costs. In some embodiments, the power may selectively be switched ON and OFF by a relay or other suitable power control circuit, such as a zone controller. The power control circuit may switch the power ON and OFF responsive to sensor signals from a temperature sensor and/or responsive to control signals from a thermostat implementing a temperature regulation process. To this end the temperature sensor or thermostat may be operationally connected to the relay or other suitable control circuit.

Alternatively, the pump may be configured to receive the start and stop triggers as start and stop control signals, respectively, directly or indirectly from a thermostat. To this end, the pump may be communicatively connected to the thermostat, either directly or indirectly, e.g. via a control circuit that is configured to receive the control signals from the thermostat. To this end, the communicative connection of the pump to the thermostat or control circuit may be a wired or wireless connection or a combination thereof. Accordingly, in some embodiments, the pump may continuously receive operational power and the pump controller may control operation of the pump based on the received start/stop control signals.

In some embodiments, the first operational mode is a first constant parameter mode during which the pump controller controls the pump to operate with a predetermined reference parameter at a first parameter value and wherein the second operational mode is a second constant parameter mode during which the pump controller controls the pump to operate with said predetermined reference parameter at a second parameter value, higher than the first parameter value. In particular, the predetermined reference parameter may be an impeller speed, a fluid flow or a fluid pressure. Accordingly, in some embodiments, when operated in the second operational mode, the pump is operated at a higher speed than in the first operational mode and/or operated such that it provides a higher flow and/or higher pressure than in the first operational mode. Operation in the first and second operational modes may thus be implemented by the pump controller based on, in particular entirely based on, internal parameters of the pump, in particular information from the pump control circuit and/or from internal sensors of the pump. Generally, the first operational mode may result in an energy consumption smaller than an energy consumption associated with the second operational mode.

In particular, in one embodiment, first operational mode is a first constant speed mode during which the pump controller controls the pump to drive an impeller of the pump at a first speed and wherein the second operational mode is a second constant speed mode during which the pump controller controls the pump to drive the impeller at a second speed, higher than the first speed.

The duration of the first time interval may be predetermined, such as a user-configurable, and/or it may automatically be selected by the pump controller according to at least a first selection criterion. Examples of first selection criteria include a selection based on the time of year, a selection based on the average ON time of the pump, etc. It will be appreciated that a combination of automatic selection of the duration of the first time interval and one or more predetermined durations may also be implemented. For example, the pump controller may automatically select a duration from a set of predetermined durations, e.g. automatically switch between a summer setting and a winter setting.

In some embodiments, the first time interval is between 10 min. and 120 min., such as between 20 min. and 60 min. However, in other embodiments, other time intervals may be chosen.

In some embodiments, controlling the pump to change pump operation to the second operational mode comprises controlling the pump to gradually, in particular continuously or incrementally, transition between the first and the second operational modes over a second time interval. In particular, the pump controller may be configured to gradually increase the predetermined reference parameter—e.g. the speed, flow or pressure—between the first parameter value and the second parameter value, thereby avoiding abrupt changes in the flow or pressure in one zone to cause sudden changes in other zones of the zoned heating or cooling system. In some embodiments, the reference parameter may be increased incrementally in two or more steps. In some embodiments, during the second time interval, the pump may thus be operated at one or more intermediate modes with the reference parameter at respective intermediate parameters. The rate at which the reference parameter value is increased, and/or the duration of the second time interval may be predetermined, such as user-configurable, and/or automatically selected. The rate may be constant or vary during the transition between the two operational models. In one embodiment, a short duration of the first time interval may be combined with long second time interval, optionally such that the rate of change of the reference parameter value slowly increases at the beginning of the second time interval. In other embodiments a long first time interval may be combined with a shorter second time interval. In particular, in some embodiments, the second time interval has a duration of between 20% and 70% of the duration of the first time interval. An automatic selection of the second time interval may be based on a second selection criterion. Examples, of the second selection criteria may include a selection based on the time of year and/or a selection based on the average observed ON periods and/or a selection based on the duration of the first time interval.

In some embodiments, controlling the pump to change pump operation to the second operational mode further comprises subsequently controlling the pump to maintain operation in the second operational mode until receipt of a stop trigger, e.g. until the pump is powered off. Accordingly, pump control may be implemented in a simple manner based only on two operational modes, optionally including additional intermediate operational modes.

In a zoned heating or cooling system with multiple zones, different zones are typically supplied with fluid by respective pumps. In such a system, changes of the operational mode of one pump may affect the pressure and/or flow conditions not only in the zone supplied by said pump but also in other zones, as the zones are connected to the same network of pipes. For example, if one of the pumps increases the flow into one zone, other zones may experience a decrease in flow, which in turn may result in undesirable fluctuations of room temperatures in the zones and a reduced level of comfort. It is thus desirable to provide a pump control that can account for such changes without the need for a centralised control of all pumps or communication between the pumps.

Accordingly, in some embodiments, the pump controller is further configured to monitor fluid flow through the pump, thereby allowing the pump controller to react to undesired changes of the flow. While flow monitoring may, in some embodiments, be based on a flow sensor, in other embodiments the flow through the pump is estimated from other parameters, thereby avoiding costly additional sensors. In particular, various embodiments of the pump include a pump motor, in particular an electric pump motor, operationally coupled to the pump controller, and monitoring the fluid flow may comprise estimating the fluid flow from one or more operational parameters of the pump motor, such as from a current motor power.

In some embodiments, the pump controller is further configured to control the pump operation responsive to the monitored fluid flow. In particular, in some embodiments, when the pump is operated in the first operational mode and if the monitored fluid flow decreases below a lower limit, the pump controller may control the pump to change pump operation to the second operational mode, or to a third operational mode, the third operational mode being different from the first and second operational modes, the second and/or third operational modes providing a higher flow than the first operational mode. Accordingly, while accepting smaller variations of the flow, the pump may efficiently react to a strong decrease in flow. In some embodiments, the pump controller is further configured to control the pump to maintain operation in the second or third operational mode until receipt of a stop trigger.

While the lower flow limit may be predetermined, such as user-configurable, the pump controller is preferably configured to adaptively determine the lower flow limit, thereby allowing the pump to automatically adapt to the typical operational conditions of a specific heating or cooling system. In particular, in some embodiments, the pump controller is configured to compute, from the monitored fluid flow, a normal flow, in particular a normal mean flow, through the pump, and to determine the lower flow limit from the computed normal flow, in particular to determine the lower flow limit as a predetermined fraction of, or offset from, the determined normal flow. The normal flow may be determined as an average over a predetermined time window or as a weighted average, e.g. by suitably filtering a time series of monitored flow values, e.g. with a predetermined forgetting factor. In some embodiments, the pump controller comprises a memory, in particular a persistent memory, for storing the determined normal flow so as to make the determined normal flow available after a subsequent stop and start of the pump.

In some embodiments, the computed normal flow is indicative of a normal, such as an average, flow of the pump when operated in the first operational mode. Alternatively, the computed normal flow is indicative of a normal, such as an average, flow of the pump when operated during the first time interval, i.e. when operated in the first operational mode or when operated in the second or third operational mode responsive to a drop in the monitored flow below the lower flow limit.

The present disclosure relates to different aspects, including the pump described above and in the following, further methods, systems, devices and product means, each yielding one or more of the benefits and advantages described in connection with one or more of the other aspects, and each having one or more embodiments corresponding to the embodiments described in connection with one or more of the other aspects described herein and/or as disclosed in the appended claims.

In particular, another aspect disclosed herein relates to embodiments of a method of controlling a pump for operation in a zoned heating or cooling system responsive to start and stop triggers based on a sensed zone temperature of a zone of the zoned heating or cooling system, wherein the method comprises:
responsive to receiving a start trigger, controlling the pump to start pump operation in a first operational mode;
in the absence of a stop trigger during at least a first time interval, automatically controlling the pump to change pump operation after the first time interval to a second operational mode, different from the first operational mode; and
responsive to receiving a stop signal, controlling the pump to stop pump operation.

It is noted that features of the method described above and in the following may be implemented at least in part in software or firmware and carried out on a processing unit, in particular a pump controller, caused by the execution of program code means such as computer-executable instructions. Here and in the following, the terms pump controller and processing unit comprise any circuit and/or device suitably adapted to perform the above functions. In particular, the above terms comprise general- or special-purpose programmable microprocessors, Digital Signal Processors (DSP), Application Specific Integrated Circuits (ASIC), Programmable Logic Arrays (PLA), Field Programmable Gate Arrays (FPGA), Graphical Processing Units (GPU), special purpose electronic circuits, etc., or a combination thereof.

Yet another aspect disclosed herein relates to embodiments of a pump controller configured to perform the steps of the method disclosed herein.

Yet another aspect disclosed herein relates to embodiments of a computer program configured to cause a processing unit, in particular a pump controller, to perform the steps of the method described above and in the following. A computer program may comprise program code means adapted to cause a processing unit to perform the steps of the method disclosed above and in the following when the program code means are executed on the processing unit. The computer program may be stored on a computer-readable storage medium or embodied as a data signal. The storage medium may comprise any suitable circuitry or device for storing data, such as a RAM, a ROM, an EPROM, EEPROM, flash memory, magnetic or optical storage device, such as a CD ROM, a DVD, a hard disk, and/or the like.

According to yet another aspect, disclosed herein are embodiments of a zoned heating or cooling system including a network of fluid conduits defining multiple zones, a plurality of pumps as disclosed herein, each pump configured to pump fluid through a respective one of the zones, and a plurality of thermostats, each thermostat being directly or indirectly operationally connected to a respective one of the plurality of pumps.

### BRIEF DESCRIPTION OF THE DRAWINGS

The above and other aspects will be apparent and elucidated from the embodiments described in the following with reference to the drawing in which:

FIG. 1 schematically illustrates an embodiment of a zoned heating or cooling system.

FIG. 2 schematically illustrates an embodiment of a pump for a zoned heating or cooling system.

FIG. 3 schematically illustrates an embodiment of a method of controlling a pump for operation in a zoned heating or cooling system.

FIG. 4 schematically illustrates operation of an embodiment of a pump for a zoned heating or cooling system.

FIG. 5 shows measured fluid flows in respective zones of a zoned heating or cooling system.

FIG. 6 schematically illustrates another embodiment of a method of controlling a pump for operation in a zoned heating or cooling system.

FIG. 7 schematically illustrates operation of another embodiment of a pump for a zoned heating or cooling system.

### DETAILED DESCRIPTION

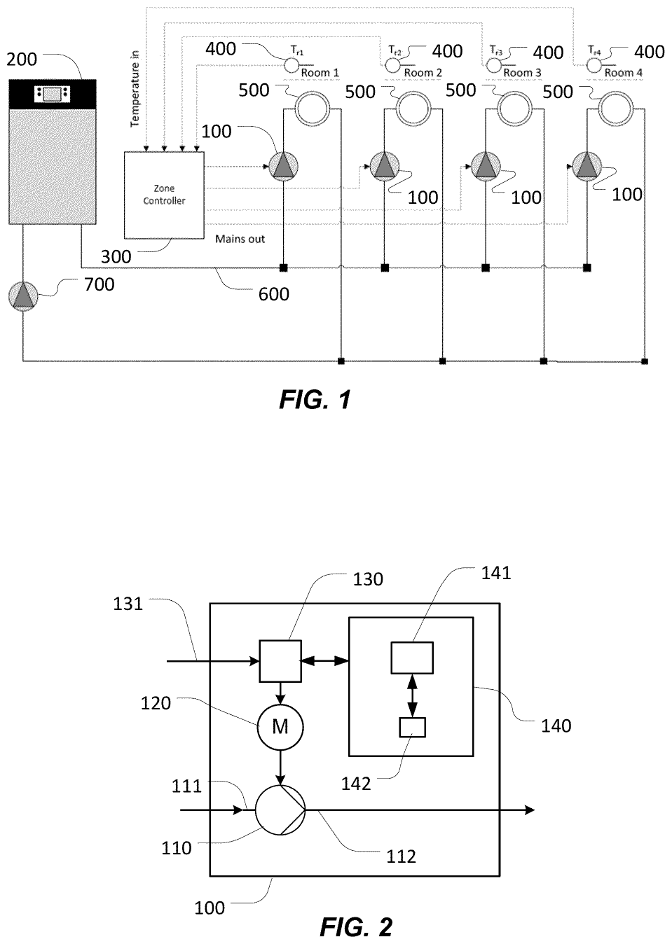

FIG. 1 schematically illustrates an embodiment of a zoned heating or cooling system, such as a zoned HVAC system. The system comprises a heat or cooling source 200 for heating or cooling a fluid to be distributed throughout the heating or cooling system. Examples of a heat source include a water boiler and examples of a cooling source include a chiller or cooling tower. Other examples of heat or cooling sources include heat exchangers, furnaces, etc. The fluid is used as a medium to transport energy throughout the system. Generally, the fluid may be a liquid, in particular water, or a gas, in particular air. The system comprises a network of fluid conduits 600, such as pipes, for distributing the heated or cooled fluid to multiple terminal units 500 throughout the system, e.g. to respective parts of a building. To this end, the system comprises a plurality of pumps 100. The terminal units 500 may be configured to exchange heat between the fluid and the air in a proximity of the terminal unit. Examples of terminal units include radiators, heat exchangers, etc.

A zoned heating or cooling system includes a plurality of pumps configured to feed the fluid into respective parts of the network of conduits so as to control fluid flow to these respective parts. The zoned, heating or cooling system thus comprises a plurality of pumps, each providing fluid flow to a respective part of the network of pipes and, hence, to respective sets of terminal units. The terminal units associated with different parts of the network of pipes and supplied by different pumps are typically located in respective parts of a building, such as different rooms or different floors of a building. The respective parts of the network of pipes and the associated sets of terminal units are also referred to as zones of the zoned heating or cooling system, as they service respective zones of a building. Each zone may include one or more terminal units. Similarly, each zone may include one or more pumps 100. As illustrated in FIG. 1, respective zones may receive fluid from a common supply conduit. Similarly, the respective zones may feed return fluid into a common return conduit. Accordingly, it will be appreciated that changes in the fluid flow within one zone may influence the fluid flow in other zones.

The zoned heating or cooling system further comprises a plurality of thermostats 400, each located in a respective part of the building and associated with one of the zones of the zoned heating or cooling system. Each thermostat is arranged to measure a zone temperature, in particular a room temperate in the zone where the thermostat is located. Each of the pumps 100 is controlled based on a respective one of the thermostats 400, in particular the thermostat associated with the zone to which the pump supplies fluid. It will be appreciated that a zone may include one or more thermostats, i.e. each pump may be controlled based on a respective set of one or more thermostats, such that different pumps are controllable by different sets of thermostats. Accordingly, the system may individually control fluid supply to the respective zones based on measured zone temperatures in the respective zones.

To this end, the embodiment of FIG. 1 includes a zone controller unit 300, which receives sensor and/or control signals from each of the thermostats 400, in particular sensor signals indicative of the zone temperature measured by the thermostat and/or control signals indicative of whether the measured zone temperature exceeds or has decreased below one or more pre-set threshold temperature. The zone controller unit 300 controls the power supply to each of the pumps 100 individually and responsive to the sensor and/or control signals from the thermostat 400 associated with the same zone as the pump. In particular, the zone controller 300 may selectively switch the power of individual pumps 100 ON and OFF responsive to the sensor and/or control signals from the corresponding thermostats 400. Switching the power ON and OFF thus provides a start and stop trigger to the pump. In some embodiments, the pumps 100 do not receive any other control signals from the zone controller, the thermostats or the other pumps, i.e. the need for wiring or communicative connections of the individual pumps is minimized.

However, it will be appreciated that, in other embodiments, the pumps 100 may receive start and stop signals in a different manner. For example, the pumps 100 may receive control signals directly from the corresponding thermostat 400, e.g. via a wired or wireless connection. In such an embodiment, the zone controller may be omitted and each pump may be connected to a suitable power supply. Yet alternatively, the thermostats may be connected to the zone controller and the pumps may receive start and stop control signals from the zone controller independently of the power supply.

The pumps may be of any suitable type, such as centrifugal pumps, that can be operated in at least two operational modes, e.g. at two different speeds. An example of a suitable pump will be described in connection with FIG. 2.

It will be appreciated that the heating or cooling system may comprise alternative or additional components, e.g. a return pump 700, multiple heat or cooling sources, etc.

It will further be appreciated that the regulation of the zone temperatures may be implemented in a different manner. For example, instead of the thermostats, the system may include multiple temperatures sensors that measure the zone temperatures in the respective zone and that send sensor signals to a zone controller. The zone controller may then implement a temperature regulation process and determine when to switch the corresponding pump ON or OFF, i.e. the thermostat function may be implemented as a distributed function, distributed between temperature sensors and a regulating module.

FIG. 2 schematically illustrates an embodiment of a pump for a zoned heating or cooling system. The pump, generally designated 100, may be a centrifugal pump or a different type of pump. The pump 100 includes an impeller 110 or other fluid displacement member for pumping fluid from an inlet 111 to an outlet 112 of the pump. The pump further includes a pump controller 140 for controlling operation of the pump and a pump motor 120, in particular an electrical motor, for driving the impeller 110. The pump may further include a frequency converter 130 or other motor drive circuit for allowing the impeller to be driven at different speeds. To this end, the pump has an electrical interface 131 for receiving electrical operating power.

During operation, the motor 120 drives the impeller 110 causing the pump to pump fluid from the inlet 111 to the outlet 112.

The pump controller 140 comprises a processing unit 141, such as a suitably programmed microprocessor or otherwise suitably configured circuitry, and a memory 142. The memory 142 may have stored thereon a computer program and/or data for use by the processing unit 141. During operation, the pump controller controls operation of the pump, e.g. by controlling the frequency converter 130 and/or otherwise. In particular, the pump controller controls the pump to selectively operate in at least a first and a second operational modes as described herein. During operation, the pump controller may receive input values from the frequency converter and/or the pump motor and/or otherwise. The input values may be indicative of a current power (P), in particular the electrical power, of the pump motor and the current rotational speed (rpm) of the impeller. The pump controller may compute a computed flow rate Q of fluid flow through the pump 100 based on the received input values, e.g. based on a set of predetermined representations of power curves and flow relationships, which may be stored in the memory 142. Alternatively or additionally, in some embodiments, the pump may include one or more internal sensors, such as a pressure sensor or a flow sensor, and the pump controller may receive sensor signals from such sensors. The pump controller may thus control operation of the pump partly based on the received input values and/or based on the sensor signals.

Examples of a method for controlling operation of a pump for a zoned heating or cooling system, in particular for the pump of FIG. 2 and/or the pumps of FIG. 1, will be described in the following.

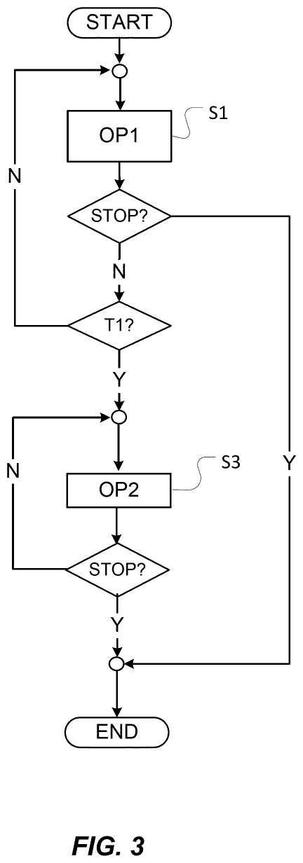

FIG. 3 schematically illustrates an embodiment of a method of controlling a pump for operation in a zoned heating or cooling system.

As mentioned above, start and stop of the operation of the pump are controlled based on measured zone temperatures, e.g. based on control signals from a thermostat measuring the zone temperature in the zone supplied by the pump. Upon receipt of a start trigger, e.g. upon switching the pump power ON or upon receipt of another type of start trigger, in step S1, the pump controller controls the pump to operate in a first operational mode. For example, in a heating system, the start trigger will typically be caused by the room temperature in the zone supplied by the pump falling below a certain threshold. The first operational mode may be a constant speed mode, a constant flow mode or another suitable operational mode. In a constant speed mode, the pump controller controls the pump to operate at a constant speed, such as at a predetermined speed. In a constant flow mode, the pump controller controls the pump to operate such that a resulting fluid flow between the pumps inlet and outlet is maintained constant. To this end, the pump controller may receive measured flow data from a flow sensor or estimate the flow based on input from the pump motor and/or frequency converter, e.g. input about the current power and rpm. If the pump is powered OFF again, or otherwise receives a stop trigger, the pump stops operation again. In the absence of a stop trigger, the pump controller continues operation of the pump in the first operational mode for a first time interval T1. The duration of the first time interval may be predetermined or it may be automatically be selected by the pump controller, e.g. based on the time of year, based on previously determined average durations between start and stop signals, and/or the like. When the pump has operated in the first operational mode for the first time interval without having received a stop trigger, the pump controller controls the pump in step S3 to change operational mode to a second operational mode, which is different from the first operational mode. The second operational mode may also be a constant speed mode or a constant flow mode as described above, but where the speed or flow is higher than the corresponding speed or flow during the first operational mode. Generally, in some embodiments the second operational mode may be a mode with a higher impeller speed and/or providing a higher fluid flow and/or providing a higher fluid pressure than the first operational mode. The transition from the first to the second operational mode is preferably performed gradually over a second time interval, which also may be predetermined or automatically selected. The gradual transition may be implemented by continuously changing a reference parameter such as the pump speed or by step-wise changing the reference parameter.

Once the transition to the second operational mode is completed, i.e. after the second time interval, the pump controller continues to control the pump to operate in the second operation mode until the pump is again powered down or otherwise receives a stop trigger. For example, in a heating system, the stop trigger will typically be caused by the room temperature in the zone supplied by the pump exceeding a certain threshold.

Upon receipt of the stop trigger during the transition to the second operational mode or while operating in the second operational mode, the pump stops operation until it is again powered on or otherwise receives a start trigger.

In summary, in the above and in other embodiments, the pump power is controlled externally by thermostats in each respective zone. The pump does, for that reason, not have any feedback available for the control algorithm on the conditions within the zones. To compensate for the lack of information, the pump control algorithm utilizes the information it obtains in its ON period, namely the pump ON time, i.e. the time elapsed since the pump has been powered on or has otherwise received a start trigger. The algorithm analyzes the ON time to estimate the energy requirement of the zone. The pump starts in the first operational mode and runs for a first time interval. If the pump has been running for more than the first time interval, the algorithm starts to ramp up the pump operation towards a second operational mode. The transition occurs over a second time interval, unless interrupted by a stop trigger, e.g. by the pump being powered OFF. When the pump reaches the second operational mode, it maintains this setting until the pump receives a stop trigger. This process repeats for each power cycle.

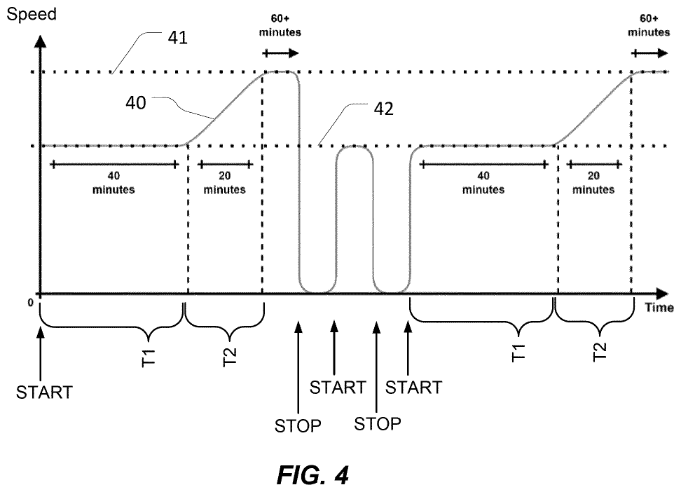

FIG. 4 schematically illustrates operation of a pump for a zoned heating or cooling system when operated by the process of FIG. 3. In the example of FIG. 4, the first time interval is selected to last 40 minutes and the second time interval is selected to last 20 minutes. However, it will be appreciated that in other embodiments, other durations of the first and/or second time interval may be chosen, or the time intervals may automatically be adapted by the pump controller or otherwise.

In the example of FIG. 4, the first and second operational modes are constant speed modes, and FIG. 4 illustrates and example of the pump speed 40 as a function of time. However, in other embodiments, the pump controller may control the pump based on a different reference parameter e.g. flow and/or pressure.

At time T=0, the pump is powered ON and is controlled to operate in the first operational mode at a first constant speed 42. After a first time interval T1, which is set to 40 minutes in this example, the pump speed is ramped up to the second constant speed 41, which is higher than the first constant speed, over a duration of T2=20 minutes, and the pump continues to operate at the second constant speed until the pump power is switched OFF again. When the power is subsequently switched ON again, the pump starts again operation in the first operational mode. If the power is switched OFF before the first time interval T1 has elapsed, the pump stops operation without having ramped up to the second speed.

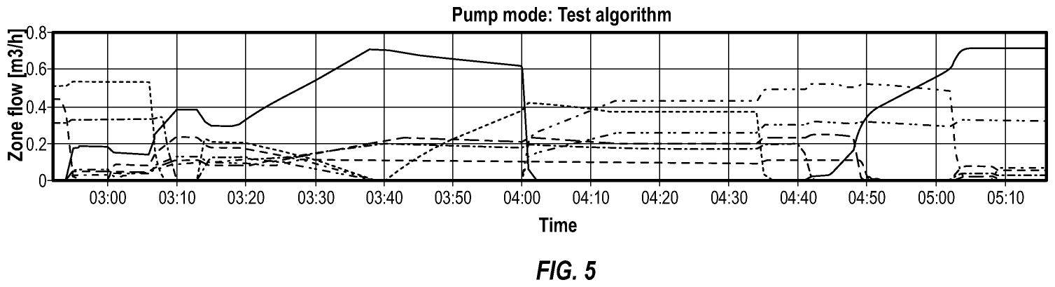

Embodiments of the pump control method disclosed herein do not require communication between the various pumps of a zoned heating or cooling system, thus making the control algorithm independent from external zone pumps and their operating state. However, as the pumps do not communicate and operate independently, the method may cause operation of one pump to affect the fluid flow in other zones, as can be seen from the example shown in FIG. 5.

FIG. 5 shows measured fluid flows in respective zones of a zoned heating or cooling system. As can be appreciated from FIG. 5, the ramping up of the pump speed of one pump, thus increasing its flow, may cause a pressure loss within the shared load to rise accordingly, requiring all other pumps to overcome the increased pressure loss to provide the same flow within each of their respective zones. FIG. 5 illustrates how the flow of the zones may fluctuate as a result of other pumps trying to reach the heating requirement by activating the ramping up according to the control process described above.

In the following a modification of the control process will be described that improves the operation of the overall system.

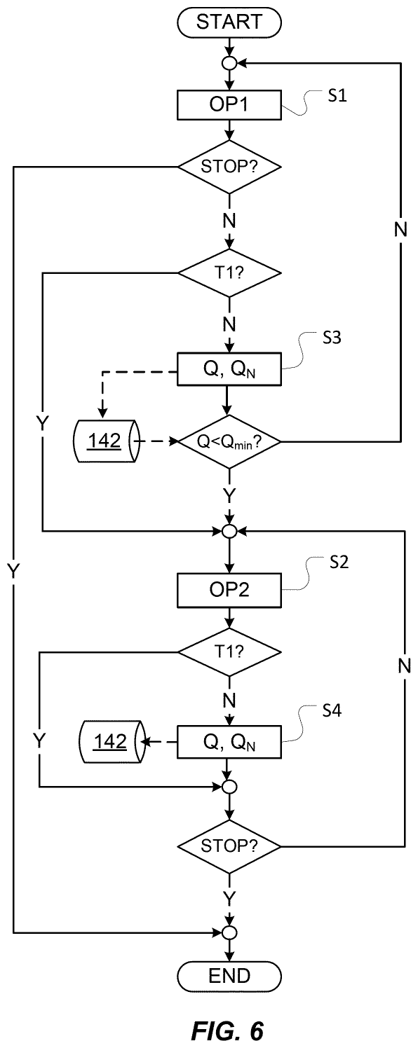

FIG. 6 schematically illustrates another embodiment of a method of controlling a pump for operation in a zoned heating or cooling system. The process of FIG. 6 is similar to the process of FIG. 4 in that it relies on the thermostat-based external start and stop triggers as the only external control. To this end, the pump implements a timing schedule where the pump initially operates in a first operational mode (step S1) for no more than a first time interval T1 and then, over a second time interval T2, ramps up to a second operational mode (step S3), which is maintained until the pump receives a stop trigger (e.g. until power is switched OFF), all as described in connection with FIG. 4.

The process of FIG. 6 differs from the process of FIG. 4 in that it includes an additional step S2 where the process monitors the current flow Q through the pump, at least during the first time interval. The process further determines a normal flow Q_{N}, e.g. an average flow over a certain time window or a weighted average of previous flows.

The flow analysis may be implemented as a moving average with a forgetting factor, continuously updating at a sampling rate, at least while the pump is running in the first operational mode or at least while operating during the first time interval:

$${Q}_{N} ( k ) = α \cdot Q ( k ) + ( 1 - α ) \cdot {Q}_{N} ( k - 1 ) ,$$

Where Q_{N}(k) denotes the computed normal flow at time step k, Q(k) denotes the measured or estimated current flow through the pump at time step k, and 0≤α≤1 is a forgetting factor.

The forgetting factor may e.g. be set to α=1−e^{T}^{ₛ}^{/τ}, where t is a suitable filter coefficient and Tₛ is the sampling time of the flow measurement.

The process may update the normal flow of the zone for each sample and save the computed normal flow to persistent storage, e.g. in memory 142, at each pump shutdown. The normal flow Q_{N} allows the process to determine when the current flow Q deviates from regular operation due to circumstances, which the pump does not receive any information about, but which often is caused by a flow increase through the shared load of the zoned heating or cooling system.

The process further determines whether the monitored flow through the pump deviates from the normal flow more than a predetermined threshold. To this end, the process compares the current flow with a lower flow limit Qₘᵢₙ, which in turn is a function of the normal flow. For example, Qₘᵢₙ, may be a predetermined fraction, e.g. 75% of the normal flow, or it may be set to be a constant offset lower than the normal flow. If the monitored current flow falls below the lower flow limit, the process changes pump operation to the second operational mode, even if the first time interval T1 has not yet lapsed. This change into the second operational mode may be performed immediately or at least over a shorter transitional period, shorter than the second time interval. It will be appreciated that the choice of the lower flow limit may involve a balance between operational efficiency of the system and user comfort. A lower flow limit close to the normal flow may result in smaller and/or less frequent temperature/flow drops and, hence, in a higher user comfort. A smaller lower flow limit, further away from the normal flow, may cause the pump to operate less frequently in the second operational mode, i.e. may cause the pump to operate more often in the first operational mode, which is typically more energy efficient.

In some embodiments, the process only updates the normal flow when operating in the first operational mode. In the variant of the process shown in FIG. 6, the process also updates the normal flow in step S4 when operating in the second operational mode, as long as the first time interval has not yet lapsed, i.e. only if the transition into the second operational mode was triggered by the monitored flow dropping below the lower flow limit. In such embodiments, the filter coefficient t may be selected to cause a slower update when in the second operational mode than in the normal, first operational mode, thereby ensuring that the process does not get stuck in the second operational mode. In particular, this way or otherwise, embodiments of the process may prevent that the estimated normal flow increases such that the process, after a restart of the pump, would directly transition into the second operational mode.

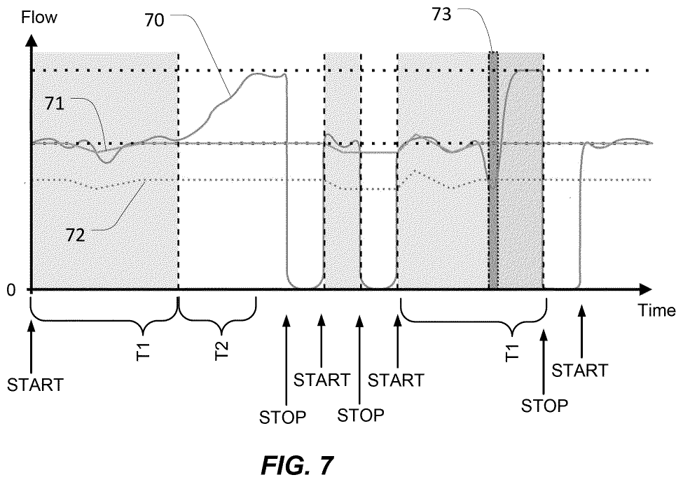

An example of an operation of a pump implementing the process of FIG. 6 is illustrated in FIG. 7.

In particular, FIG. 7 shows the actual flow 70 through the pump, the computed normal flow 71 and the associated lower flow limit 72 as a function of time.

During the shaded periods, i.e. when operating in the first operational mode, and when operating in the second operational mode responsive to a detected flow drop below the lower flow limit, the process updates the normal flow 71. Unless the monitored flow 70 drops below the lower flow limit 72, the pump operation corresponds to the operation illustrated in FIG. 4. However, in the example of FIG. 7, the monitored flow 70 drops below the lower flow limit 72 during a time interval 73. This causes the pump to change operational mode to the second operational mode, resulting in an increase in the actual flow 70.

The detection of the flow dropping below the threshold flow at time 73 thus acts as a trigger, allowing a zone pump to switch to the second operational mode early, i.e. earlier than the completion of the first time interval, based on the monitored flow through the zone. When triggered by the decrease in flow, the second operational mode is maintained throughout the remaining power cycle, i.e. until the next stop trigger. This avoids unduly oscillating the control setting between the first and second operational modes.

Several embodiments of various aspects disclosed herein may be summarized as follows:

Embodiment 1: A pump for a zoned heating or cooling system, the pump being configured to be started and stopped based on a sensed zone temperature of a zone of the zoned heating or cooling system, wherein the pump comprises a pump controller configured to:
responsive to receiving a start trigger, control the pump to start pump operation in a first operational mode;
in the absence of a stop trigger during at least a first time interval after receipt of the start trigger, to automatically control the pump to change pump operation after the first time interval to a second operational mode, different from the first operational mode; and
responsive to receiving a stop trigger, to control the pump to stop pump operation.

Embodiment 2: The pump according to embodiment 1, wherein the pump controller is configured to control the pump operation of the pump based on the start and stop signals as only external control inputs.

Embodiment 3: The pump according to embodiment 1 or 2; wherein the pump is configured to receive the start and stop triggers as a start and stop, respectively, of receipt of operational power for driving the pump.

Embodiment 4: The pump according to embodiment 1 or 2; wherein the pump is configured to receive the start and stop triggers as start and stop control signals, respectively, directly or indirectly from the thermostat.

Embodiment 5: The pump according to any one of the preceding embodiments, wherein the first operational mode is a first constant parameter mode during which the pump controller controls the pump to operate with a predetermined reference parameter at a first parameter value and wherein the second operational mode is a second constant parameter mode during which the pump controller controls the pump to operate with said predetermined reference parameter at a second parameter value, higher than the first parameter value.

Embodiment 6: The pump according to embodiment 5, wherein the predetermined reference parameter is an impeller speed, a fluid flow or a fluid pressure.

Embodiment 7: The pump according to any one of the preceding embodiments, wherein the first time interval is a predetermined and/or user-configurable time interval, such as a time interval between 20 min. and 60 min.

Embodiment 8: The pump according to any one of the preceding embodiments, wherein the pump controller is configured to automatically select or adjust the first time interval based on at least a first selection criterion.

Embodiment 9: The pump according to any one of the preceding embodiments, wherein controlling the pump to change pump operation to the second operational mode comprises controlling the pump to gradually, in particular continuously or incrementally, transition between the first and the second operational modes over a second time interval.

Embodiment 10: The pump according to embodiment 9, wherein the second time interval is a predetermined and/or user-configurable time interval, in particular a time interval between 10 minutes and 30 minutes.

Embodiment 11: The pump according to embodiment 9 or 10, wherein the pump controller is configured to automatically select or adjust the second time interval based on at least a second selection criterion.

Embodiment 12: The pump according to any one of embodiments 9 through 11, wherein the second time interval is shorter than first time interval, such as between 20% and 70% of the first time interval.

Embodiment 13: The pump according to any one of the preceding embodiments, wherein controlling the pump to change pump operation to the second operational mode further comprises controlling the pump to maintain operation in the second operational mode until receipt of a stop trigger.

Embodiment 14: The pump according to any one of the preceding embodiments, wherein the pump controller is further configured to monitor fluid flow through the pump.

Embodiment 15: The pump according to embodiment 14, comprising a pump motor, in particular an electric pump motor, operationally coupled to the pump controller, and wherein monitoring the fluid flow comprises estimating the fluid flow from one or more operational parameters of the pump motor, such as from a current motor power.

Embodiment 16: The pump according to embodiment 14 or 15, wherein the pump controller is further configured to control the pump operation responsive to the monitored fluid flow.

Embodiment 17: The pump according to embodiment 16, when dependent on any one of embodiments 9 through 13, wherein the pump controller is configured to control the pump to change, responsive to the monitored fluid flow decreasing below a lower flow limit during operation of the pump in the first control mode, pump operation to the second operational mode or to a third operational mode, the third operational mode being different from the first and second operational modes.

Embodiment 18: The pump according to embodiment 17, wherein the pump controller is further configured to control the pump to maintain operation in the second or third operational mode until receipt of a stop trigger.

Embodiment 19: The pump according to embodiment 17 or 18, wherein the pump controller is configured to adaptively determine the lower flow limit.

Embodiment 20: The pump according to embodiment 19, wherein the pump controller is configured to compute, from the monitored fluid flow, a normal flow, in particular a mean flow, through the pump, and to determine the lower flow limit from the computed normal flow.

Embodiment 21: A method of controlling a pump for operation in a zoned heating or cooling system responsive to start and stop triggers based on a sensed zone temperature of a zone of the zoned heating or cooling system, wherein the method comprises:
responsive to receiving a start trigger, controlling the pump to start pump operation in a first operational mode;
in the absence of a stop trigger during at least a first time interval, automatically controlling the pump to change pump operation after the first time interval to a second operational mode, different from the first operational mode; and
responsive to receiving a stop signal, controlling the pump to stop pump operation.

Embodiment 22: A computer program comprising program code configured to cause, when executed by a pump controller, the pump controller to perform the acts of the method according to embodiment 21.

Embodiment 23: A pump controller configured to perform the acts of the method according to embodiment 21.

Embodiment 24: A zoned heating or cooling system including a network of fluid conduits defining multiple zones, a plurality of pumps as defined in any one of embodiments 1 through 20, each pump configured to pump fluid through a respective one of the zones, and a plurality of thermostats, each thermostat being directly or indirectly operationally connected to a respective one of the plurality of pumps.

Embodiments of the method described herein can be implemented by means of hardware comprising several distinct elements, and/or at least in part by means of a suitably programmed microprocessor. In the apparatus claims enumerating several means, several of these means can be embodied by one and the same element, component or item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components or groups thereof.

1. A pump for a zoned heating or cooling system, the pump being configured to be started and stopped based on a sensed zone temperature of a zone of the zoned heating or cooling system, wherein the pump comprises a pump controller configured to:
responsive to receiving a start trigger, control the pump to start pump operation in a first operational mode;
in the absence of a stop trigger during at least a first time interval after receipt of the start trigger, to automatically control the pump to change pump operation after the first time interval to a second operational mode, different from the first operational mode; and
responsive to receiving a stop trigger, to control the pump to stop pump operation,
wherein the pump controller is configured to control the pump operation of the pump based on the start and stop signals as only external control inputs.

2. (canceled)

3. The pump according to claim 1, wherein the pump is configured to receive the start and stop triggers as a start and stop, respectively, of receipt of operational power for driving the pump.

4. The pump according to claim 1, wherein the pump is configured to receive the start and stop triggers as start and stop control signals, respectively, directly or indirectly from the thermostat.

5. The pump according to claim 1, wherein the first operational mode is a first constant parameter mode during which the pump controller controls the pump to operate with a predetermined reference parameter, in particular an impeller speed, a fluid flow or a fluid pressure, at a first parameter value and wherein the second operational mode is a second constant parameter mode during which the pump controller controls the pump to operate with said predetermined reference parameter at a second parameter value, higher than the first parameter value.

6. The pump according to claim 5, wherein the predetermined reference parameter is an impeller speed, a fluid flow or a fluid pressure.

7. The pump according to claim 1, wherein the first time interval is a predetermined and/or user-configurable time interval, such as a time interval between 20 min. and 60 min, and/or an automatically selected or adjusted time interval.

8. The pump according to claim 1, wherein the pump controller is configured to automatically select or adjust the first time interval based on at least a first selection criterion.

9. The pump according to claim 1, wherein controlling the pump to change pump operation to the second operational mode comprises controlling the pump to gradually, in particular continuously or incrementally, transition between the first and the second operational modes over a second time interval.

10. The pump according to claim 9, wherein the second time interval is a predetermined and/or user-configurable time interval, in particular a time interval between 10 minutes and 30 minutes.

11. The pump according to claim 9, wherein the pump controller is configured to automatically select or adjust the second time interval based on at least a second selection criterion.

12. The pump according to claim 9, wherein the second time interval is shorter than first time interval, such as between 20% and 70% of the first time interval.

13. The pump according to claim 1, wherein controlling the pump to change pump operation to the second operational mode further comprises controlling the pump to maintain operation in the second operational mode until receipt of a stop trigger.

14. The pump according to claim 1, wherein the pump controller is further configured to monitor fluid flow through the pump.

15. The pump according to claim 14, comprising a pump motor, in particular an electric pump motor, operationally coupled to the pump controller, and wherein monitoring the fluid flow comprises estimating the fluid flow from one or more operational parameters of the pump motor, such as from a current motor power.

16. The pump according to claim 14, wherein the pump controller is further configured to control the pump operation responsive to the monitored fluid flow.

17. The pump according to claim 16, wherein the pump controller is configured to control the pump to change, responsive to the monitored fluid flow decreasing below a lower flow limit during operation of the pump in the first control mode, pump operation to the second operational mode or to a third operational mode, the third operational mode being different from the first and second operational modes.

18. The pump according to claim 17, wherein the pump controller is further configured to control the pump to maintain operation in the second or third operational mode until receipt of a stop trigger.

19. The pump according to claim 17, wherein the pump controller is configured to adaptively determine the lower flow limit.

20. The pump according to claim 19, wherein the pump controller is configured to compute, from the monitored fluid flow, a normal flow, in particular a mean flow, through the pump, and to determine the lower flow limit from the computed normal flow.

21. A method of controlling a pump for operation in a zoned heating or cooling system responsive to start and stop triggers based on a sensed zone temperature of a zone of the zoned heating or cooling system, wherein operation of the pump is controlled based on the start and stop signals as only external control inputs, and wherein the method comprises:
responsive to receiving a start trigger, controlling the pump to start pump operation in a first operational mode;
in the absence of a stop trigger during at least a first time interval, automatically controlling the pump to change pump operation after the first time interval to a second operational mode, different from the first operational mode; and
responsive to receiving a stop signal, controlling the pump to stop pump operation.

22. A computer program comprising program code configured to cause, when executed by a pump controller, the pump controller to perform the acts of the method according to claim 21.

23. A pump controller configured to perform the acts of the method according to claim 21.

24. A zoned heating or cooling system including a network of fluid conduits defining multiple zones, a plurality of pumps as defined in claim 1, each pump configured to pump fluid through a respective one of the zones, and a plurality of thermostats, each thermostat being directly or indirectly operationally connected to a respective one of the plurality of pumps.
